(19) United States
(12) Patent Application Publication
(10) Pub. No.: US 2007/0289103 A1
(43) Pub. Date: Dec. 20, 2007

(54) Readygrip

(76) Inventor: Joel P. Steelman, Denton, TX (US)

Correspondence Address: JOEL P. STEELMAN, 2225 WILLOWWOOD STREET, DENTON, TX, 76205, US

(21) Appl. No.: 11/306,476

(22) Filed: Dec. 29, 2005

(51) Int. Cl. B25G 1/00

(52) U.S. Cl. 16/426

(57) ABSTRACT

The present invention is concerned with a Readygrip that can be readily attached as a second or third auxiliary handle to, and can be readily adjusted on, handheld tools that have elongated cylindrical handles that vary in diameter, have surfaces that are more or less than parallel to their axis, requires no sleeves or shims be added, the need for any tool(s) to attach or adjust has been negated and the portion gripped by the hand rotates preventing any abrasive contact between the user and the attachment or the tool.

The present invention and method of creating such invention is concerned with a Readygrip to be readily attached and readily adjusted as a auxiliary handle to handheld tools with elongated cylindrical handles such as a shovel or rake to mention two.

The device is comprised of the joining of two distinct components by a third component.

The components consist of an upper end (FIG. 2) and a lower end (FIG. 4) and connecting side rails (FIG. 3).

The upper end (FIG. 2) is comprised of two components 1 and 2 and is that portion that is gripped by the hand.

The lower end (FIG. 4) is comprised of 10 components 5 and 6 and 7 and 8 and 9 and 10 and 11 and 12 and 13 and 14 and is that portion that attaches to a tool handle (H1).

The side rails (FIG. 3) consist of one component 34, when assembled and shaped it becomes two components 3 and 4 and joins the upper end (FIG. 2) to the lower end (FIG. 4).

The sleeve 1 is a cylindrical tube, cast or extruded.

The axle 2 is cast, extruded or fabricated square tubing.

The sleeve 1 is placed over the axle 2.

The sleeve being slightly shorter than the axle with sufficient clearance between the sleeves inner wall and the outside corner points of the square axle allows the sleeve to rotate freely on the axle.

The lower end is comprised of 10 components: The upper one-half of a clamp 5, the lower one-half of a clamp 6, two threaded rods 7 and 8, two wing nuts 9 and 10, two threaded rod caps 11 and 12, one slot 13, one drilled hole 14.

The upper one-half of the clamp 5 by casting, extrusion, or fabrication in part takes the shape of an open isosceles triangle.

The single point where the sides of the open isosceles triangle meet shall become the apex.

The upper one-half of the clamp 5 is open at the bottom where wings extend outward from the right side horizontally and extend outward from the left side horizontally.

At a point on the horizontal extension (wing) to the right and to the left, a threaded rod 7 or 8) is fixed substantially perpendicular to each horizontal extension in a downward direction.

The lower one-half of the clamp 6 is a replica of the upper one-half of the clamp 5 prior to the attachment of the threaded rods 7 and 8.

A hole 14 slightly larger than the threaded rod 7 is drilled in one of the horizontal extensions of the lower one-half of the clamp 6.

A slot 13 is created slightly larger by width than the diameter of the threaded rod 8 in the remaining horizontal extension of the lower one-half of the clamp 6.

Rotate the lower one-half of the clamp 6 until it is open on top.

Join the upper one-half of the clamp 5 to the inverted lower one-half of the clamp 6 by passing the threaded rod 7 through the drilled hole 14.

Place the wing nuts 9 and 10 on the threaded rods 7 and 8.

Place the threaded rod caps 11 and 12 on the end of threaded rods 7 and 8 to prevent the wing nuts 9 and 10 from being removed.

To create the side rails 3 and 4, pass a single piece of flat side rail material 34 through the axle 2 with the sleeve 1 in place. Extend the flat side rail material 34 out both right and left sides of the axle 2 equally.

First, bend the flat side rail material 34 to a right angle at both ends of the axle 2 creating a left side rail 3 and a right side rail 4. When first bending the flat side rail material, ensure that both the right side rail 4 and left side rail 3 remain on the same plane and parallel to each other. At an equal distance down the side rails bend each right and left side rail (3 and 4) inward, keeping each on the same plane. At an equal distance down from the second bend, make a third bend. Bend the side rails (3 and 4) outward until they are parallel to each other, separated by a distance equal to the distance between the threaded rods (7 and 8).

To create a Readygrip (FIG. 5) (FIG. 6) Rotate the upper one-half of the clamp 5 until the bottom is open and the treaded rods 7 and 8 extend downward. Position the upper end where the side rails 3 and 4 extend downward and attach the left side rail 3 to the left side of the top one-half of the clamp 5 and attach the right side rail 4 to the right side of the top one-half of the clamp 5. At the point in time that both left and right side rails have been attached to their respective sides of the upper one-half of the clamp 5, a Readygrip is complete.

A Readygrip (FIG. 5) (FIG. 6) may be attached to a tool handle H1 at any point selected along the length of the tool handle.

To attach a Readygrip (FIG. 5) (FIG. 6) to a tool handle H1, place the one-half of the clamp 5 that incorporates the threaded rods 7 and 8 on the tool handle H1 with the threaded rods 7 and 8 extending downward. Rotate the bottom one-half of the clamp 6 on the threaded rod 7 until the slotted portion 13 of the lower one-half of the clamp 6 is received by the remaining threaded rod 8 that extends down from the upper one-half of the clamp 5. Adjust the Readygrip (FIG. 5) (FIG. 6) on the tool handle H1 and tighten both wing nuts 9 and 10 equally. At the point in time that both wing nuts 9 and 10 have been tightened, the attachment of the Readygrip is complete.

### BACKGROUND OF THE INVENTION

The benefits of attaching a second or even a third handgrip to elongated cylindrical tool handles that are handheld covers a wide range of tools and users including the casual homeowner as well as professionals performing gardening, agricultural and commercial tasks.

The concept of multiple handled tools is not new.

The concept of a handgrip that rotates is not new.

The concept of using a device that is comprised of the joining of opposing halves to create a clamp is not new.

Discovery of one such device that has utilized some of the previously mentioned elements in creating an attachable handgrip to be used as an auxiliary handle to handheld tools with elongated cylindrical handles is that certain U.S. Pat. No. 5,499,852 of Mar. 19, 1996.

The present invention, the Readygrip, of which a patent is being applied for, when compared to that invention U.S. Pat. No. 5,499,852 brings to the fore-front distinct differences in the areas of fabrication, attachment, and utilization.

When comparing the claims made for the present invention the Readygrip to the actual functionality of and claims made by that certain “Second Handle Attachment for a Tool” known as U.S. pat. No. 5,499,852 that certain “Second Handle Attachment for a Tool” U.S. Pat. No. 5,499,852 is deficient in that the claims made of the present invention concerning the Readygrip cannot be made by that certain “Second Handle Attachment for a Tool” known as U.S. Pat. No. 5,499,852.

Fact: Tool handle manufacturers do not have a standard for tool handle size by diameter.

Fact: Tool handle manufacturers manufacture tool handles that have tool handle surfaces that are more or less than parallel to their axis.

Fact: Tool handle manufacturers permanently attach handgrips to the end of tool handles at the opposite end from the tool.

These facts limit the “Second Handle Attachment for a Tool” U.S. Pat. No. 5,499,852 from being readily attached to many of the tool handles intended and claimed.

These facts prevent the “Second Handle Attachment for a Tool” U.S. Pat. No. 5,499,852 from effectively being attached to many of the tool handles intended and claimed.

The image section of the patent documents for U.S. Pat. No. 5,499,852 shall be used as a point of reference to illustrate findings of fact that puts limitations on and in some cases prevents the effective attachment of this device to tool handles intended and claimed.

The image section of the patent documents for U.S. Pat. No. 5,499,852 shall be used to illustrate findings of fact concerning problems after effective attachment to a tool handle has been achieved.

At a time when the whole of the “Second Handle Attachment for a Tool” U.S. Pat. No. 5,499,852 as illustrated by FIG. 10 of sheet 3 is assembled, the right-side of the clamp 20 and the left-side of the clamp 20 are fixed substantially parallel to each other separated at a distance determined by the length of the spacer 94.

The collective dimensions of the clamps 20 and the length of the spacer 94 will determine by mathematical calculation what diameter of tool handle 101 in FIG. 2A can effectively be received by the clamps 20. The tool handle 101 diameter is critical to ensure that a successful and functional attachment of the “Second Handle Attachment for a Tool” U.S. Pat. No. 5,499,852 occurs.

PROBLEM 1.

If the tool handle 101 diameter is too large, one must compress the tool handle 101 until the right-side and the left-side of the clamps 20 makes contact with the spacer 94 to ensure that the close tolerance of clearance between the clamps 20 and the second handle 40 is achieved as designed.

If a smaller tool handle 101 is to be received by the clamps 20, the sleeve 80 dimensions must be a part of the equation when the mathematical calculation is computed to ensure that the tool handle 101 diameter when received by the clamps 20 produces tolerances between the clamps 20 and second handle 40 that will provide a successful and functional attachment of the “Second Handle Attachment for a Tool” U.S. Pat. No. 5,499,852.

The allowable tolerance between the clamps 20 and the tool handle 101 with or without a sleeve 80 will be measured in thousands of an inch to ensure that the tool handle 101 and the clamps 20 are securely married, at the same time the second handle 40 enjoys the close tolerance to the clamps 20 as designed to ensure that the portion of the second handle 50 gripped by the user is stable.

PROBLEM 2

When the right-side and the left-side of the clamps 20 is correctly married to the second handle 40 the right-side and the left-side of the clamps 20 being substantially parallel to each other will prevent the attachment of the “Second Handle Attachment for a Tool” U.S. Pat. No. 5,499,852 to a tool handle 101 that has surfaces that are more or less than parallel to it's axis.

The surface area of contact between the clamps 20 and the tool handle 101 will be negligible. Even negligible contact between the tool handle 101 and the clamps 20 will be reliant on the tool handle meeting rigid tool handle 101 diameter tolerances mentioned in problem 1.

PROBLEM 3.

When a tool handle 101 that meets the requirements of having a diameter that is appropriately sized to be received by the clamps 20 has tool handle 101 surfaces that are parallel to its axis, and has had a handgrip permanently attached to the end of the tool handle 101 at the opposite end from the tool requires the user to completely disassembled the whole of the “Second Handle Attachment for a Tool” U.S. Pat. No. 5,499,852 to allow the clamps 20 to be placed on the tool handle 101 so that reassembly as a whole can take place.

PROBLEM 4

The fact that the middle portion of the second handle 40 is angled causes the second handle 40 to move away from the axis of the tool handle 101 laterally as the second handle 40 extends outward to the handle grip 50 creating a source of leverage. The energy created by this leverage will transfer to the tool handle 101 causing the tool handle 101 to rotate on its axis.

The force of leverage will increase if the length of the second handle 40 is extended.

The force of leverage will increase when the second handle 40 is rotated on the tool handle 101 to the right or to the left of the tool handle 101 axis as suggested by FIG. 2A and FIG. 2C.

The force of the leverage will increase whenever the load demand of the tool being used increases.

To counter the rotation of the tool handle 101, the user will have to apply energy to the tool handle 101 with the second hand in a counter rotating direction without the benefit of a lever.

PROBLEM 5

The handle grip 50 being permanently attached to the second handle 40 on one side only exposes the user to the possibility of slipping off of the handle grip 50. Conditions that could cause one to slip off of the handle grip 50 might include working condition where water is present, where ice or snow is present or when wearing gloves, etc.

PROBLEM 6

The handle grip 50 being unable to rotate will cause the user to experience abrasive contact with the handle grip 50.

### BRIEF SUMMARY of the INVENTION

The invention concerning the Readygrip is an auxiliary handgrip that readily attaches to and is readily adjusted on many tool handles that are handheld, elongated and cylindrical such as a shovel or rake to name two.

Readily attaches to and is readily adjustable on this class of tool handle, even when tool handle diameters vary.

Readily attaches to and is readily adjustable on this class of tool handle when tool handle surfaces are more or less than parallel to their axis.

Readily attaches to and is readily adjustable on this class of tool handle even when a second handle has been attached to the end of a tool handle opposite the tool.

Is readily rotated on the tool handle.

That portion gripped by the hand rotates on its own independent axle.

Is readily attached to and is readily adjusted on the tool handle without the need to employ any mechanical tool(s).

In its entirety, it exists as a whole as there are no removable parts.

The advantages over the current field of second handle attachments is that it readily attaches to and readily adjust on this class of tool handles.

Tool handle manufacturers in providing a desirable grip surface for their tool handles, design tool handles that vary in diameter over the length of the tool handle. In the varying of tool handle diameters, the tool handle surface becomes more or less than parallel to its axis.

This unique approach addresses the need to be able to readily attach and readily adjust a second or third handle to tool handles with varying diameters and to tool handles that have surfaces that are more or less than parallel to its axis without requiring any additional sleeves or shims, or requiring the use of any other mechanical tool(s).

The upper one-half of the clamp is attached to the lower one-half of the clamp by two connecting threaded rods.

The connecting rods are permanently fixed to the upper one-half on the clamp.

The lower one-half of the clamp has a drilled hole in one side that is larger than the diameter of the corresponding threaded rod of the upper one-half of the clamp.

One of the threaded rods that extend down from the upper one-half of the clamp passes through the over-sized drilled hole in the lower one-half of the clamp.

A wing nut is placed on both threaded rods that extend down from the upper one-half of the clamp.

A cap is placed on the end of each threaded rod that extends down from the upper one-half of the clamp to prevent the wing nuts from being removed.

The lower one-half of the clamp is free to rotate on the treaded rod that has passed through the drilled hole in the lower one-half of the clamp.

In the other side of the lower one-half of the clamp a slot has been created (larger by width) than the diameter of the second threaded rod of the upper one-half of the clamp.

The upper one-half of the clamp is placed on the tool handle with the treaded rods extending downward.

The lower one-half of the clamp is rotated on the threaded rod until the slot in the lower one-half of the clamp is received by the second threaded rod extending down from the upper one-half of the clamp.

The tolerance between the threaded rod of the upper one-half of the clamp and the corresponding drilled hole in the lower one-half of the clamp and the tolerance between the second threaded rod of the upper one-half of the clamp and the corresponding slot in the lower one-half of the clamp allows each one-half of the clamp to be independent of the other in that they may be more or less than parallel to each other when attached to a tool handle with a surface that is more or less than parallel to its axis.

The length of the threaded rods that connect the upper one-half of the clamp to the lower one-half of the clamp in conjunction with the size of the open triangle-shaped portion of the clamp will determine the minimum and the maximum diameter of a tool handle that can be effectively received by the clamp.

The wing nuts when tightened reduce the distance between the upper one-half of the clamp and the lower one-half of the clamp. This distance determines the diameter size of tool handle that can be effectively received by the clamp.

The side rails that connect the upper end to the upper one-half of the clamp ensures that when the upper one-half of the clamp is securely attached to a tool handle, that portion of the upper end that is gripped by the hand is also secured.

The portion gripped by the hand is connected to the upper one-half of the clamp on both right and left sides and is substantially perpendicular to and is centered on the tool handle axis. This means of construction minimizes the potential of producing any energy that would transfer to the tool handle in a way that would cause the tool handle to rotate on its axis. The fact that the portion of the attachment that is gripped by the hand is free to rotate on its own axle prevents the user from having any abrasive contact with the tool, or tool handle attachment. Being attached on both sides of the portions gripped by the hand prevents the user from slipping off of the handle. There is no need for additional sleeves or shims and no additional tool(s) are required to attach or adjust.

The method of bringing those elements together to create the second or third tool handle attachment known as the “Readygrip” offers improvements beyond solving the 6 problems mentioned in the BACKGROUND OF THE INVENTION concerning the “Second Handle Attachment for a Tool” U.S. Pat. No. 5,499,852.

### BRIEF DESCRIPTION OF SEVERAL VIEWS OF THE DRAWINGS

These and other features, aspects, and advantages of the present invention will become better understood with regard to the following description, appended claims, and accompanying drawings where:

FIG. 1 Illustrates that the Readygrip ( FIG. 5) (FIG. 6) can be and is intended to be attached at any selected point along the length of the tool handle H1.

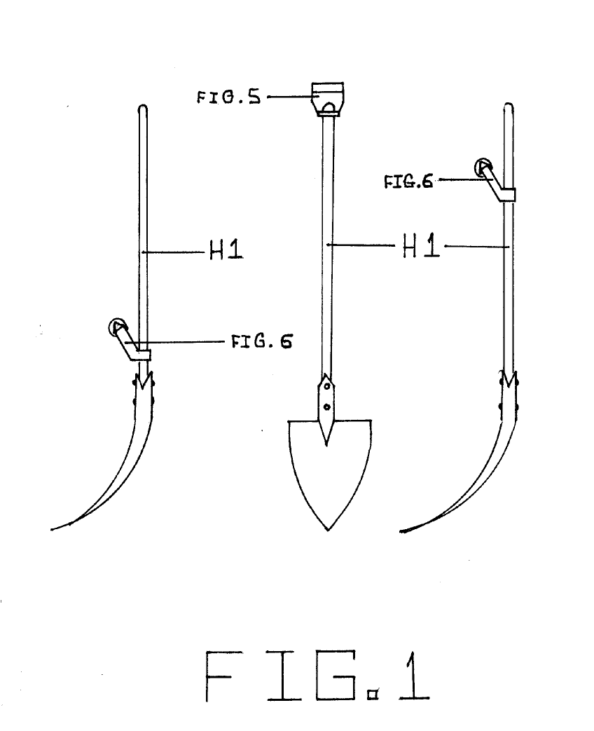

FIG. 2 Illustrates the components of the upper end and those components assembled.

FIG. 3 Illustrates the component known as the flat side rail material 34. A view where the flat side rail material has been passed thru the upper end and shaped to form the right and the left side rails. The side rails connect the upper end to the lower end.

FIG. 4 Illustrates the components of the lower end and a view of those components assembled.

FIG. 5 Illustrates a Readygrip complete by front view, and a view looking down on the lower one half of the clamp.

FIG. 6 Illustrates a Readygrip complete by side view.

H1 represents views of a tool handle that is elongated and cylindrical.
34 represents views of the flat side rail material.
1 represents views of the sleeve.
2 represents views of the axle.
3 represents views of the left side rail.
4 represents views of the right side rail.
5 represents views of the top one half of the clamp.
6 represents views of the lower one-half of the clamp.
7 represents views of the left threaded rod.
8 represents views of the right threaded rod.
9 represents views of the left wing nut.
10 represents views of the right wing nut.
11 represents views of the left rod cap.
12 represents views of the right rod cap.
13 represents views of the slot in the lower one half of the clamp 6.
14 represents views of the drilled hole in the lower one half of the clamp 6.

### DETAILED DESCRIPTION OF THE INVENTION

The present invention and method of creating such invention is concerned with a Readygrip to be readily attached and readily adjusted as a auxiliary handle to handheld tools with elongated cylindrical handles such as a shovel or rake to mention two.

The device is comprised of the joining of two distinct components by a third component.

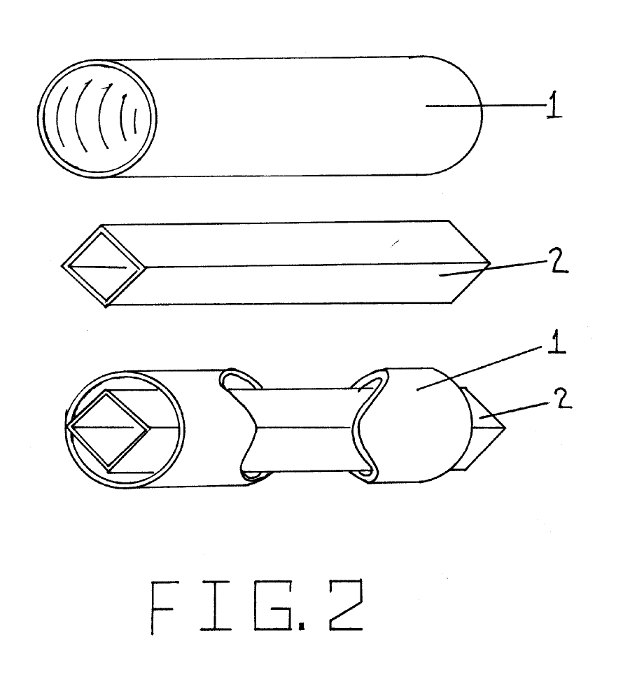

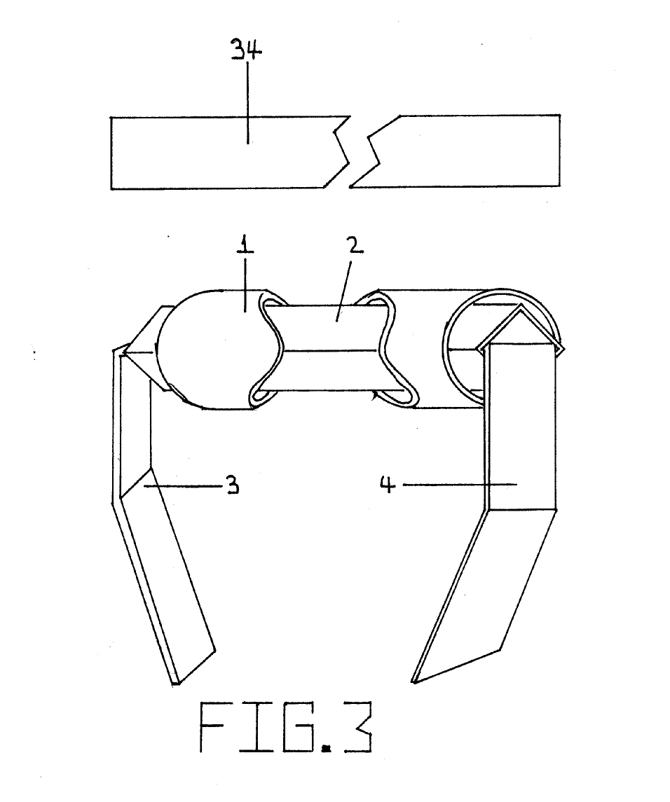

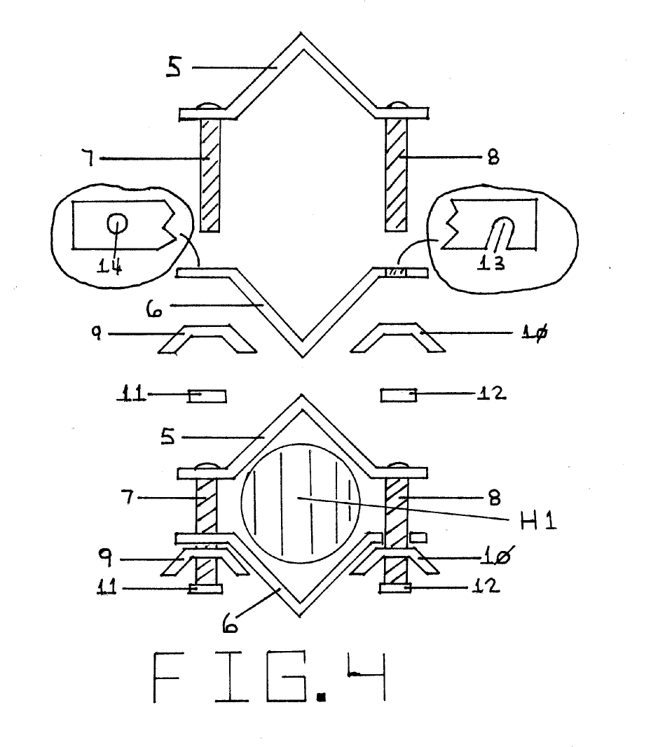

The components consist of an upper end (FIG. 2) and a lower end (FIG. 4) and connecting side rails (FIG. 3).

The upper end (FIG. 2) is comprised of two components 1 and 2 and is that portion that is gripped by the hand.

The lower end (FIG. 4) is comprised of 10 components 5 and 6 and 7 and 8 and 9 and 10 and 11 and 12 and 13 and 14 and is that portion that attaches to a tool handle (H1).

The side rails (FIG. 3) consists of one component 34, when assembled and shaped it becomes two components 3 and 4 and joins the upper end (FIG. 2) to the lower end (FIG. 4).

The sleeve 1 is a cylindrical tube, cast or extruded.

The axle 2 is cast, extruded or fabricated square tubing.

The sleeve 1 is placed over the axle 2.

The sleeve being slightly shorter than the axle with sufficient clearance between the sleeves inner wall and the outside corner points of the square axle allows the sleeve to rotate freely on the axle.

The lower end is comprised of 10 components: The upper one-half of a clamp 5, the lower one-half of a clamp 6, two threaded rods 7 and 8, two wing nuts 9 and 10, two threaded rod caps 11 and 12, one slot 13, one drilled hole 14.

The upper one-half of the clamp 5 by casting, extrusion, or fabrication in part takes the shape of an open isosceles triangle.

The single point where the sides of the open isosceles triangle meet shall become the apex.

The upper one-half of the clamp 5 is open at the bottom where wings extend outward from the right side horizontally and extend outward from the left side horizontally.

At a point on the horizontal extension (wing) to the right and to the left, a threaded rod (7 or 8) is fixed substantially perpendicular to each horizontal extension in a downward direction.

The lower one-half of the clamp 6 is a replica of the upper one-half of the clamp 5 prior to the attachment of the threaded rods 7 and 8.

A hole 14 slightly larger than the threaded rod 7 is drilled in one of the horizontal extensions of the lower one-half of the clamp 6.

A slot 13 is created slightly larger by width than the diameter of the threaded rod 8 of the upper one-half of the clamp 5 in the remaining horizontal extension of the lower one-half of the clamp 6.

Rotate the lower one-half of the clamp 6 until it is open on top.

Join the upper one-half of the clamp 5 to the inverted lower one-half of the clamp 6 by passing the threaded rod 7 through the drilled hole 14 in the horizontal extension of the lower one-half of the clamp.

Place the wing nuts 9 and 10 on the threaded rods 7 and 8.

Place the threaded rod caps 11 and 12 on the end of threaded rods 7 and 8 to prevent the wing nuts 9 and 10 from being removed.

To create the side rails 3 and 4, pass a single piece of flat side rail material 34 through the axle 2 with the sleeve 1 in place. Extend the flat side rail material 34 out both right and left sides of the axle 2 equally.

First, bend the flat side rail material 34 to a right angle at both ends of the axle 2 creating a left side rail 3 and a right side rail 4. When first bending the flat side rail material, ensure that both the right side rail 4 and left side rail 3 remain on the same plane and parallel to each other. At an equal distance down the side rails bend each right and left side rail (3 and 4) inward, keeping each on the same plane. At an equal distance down from the second bend, make a third bend. Bend the side rails (3 and 4) outward until they are parallel to each other, separated by a distance equal to the distance between the threaded rods (7 and 8).

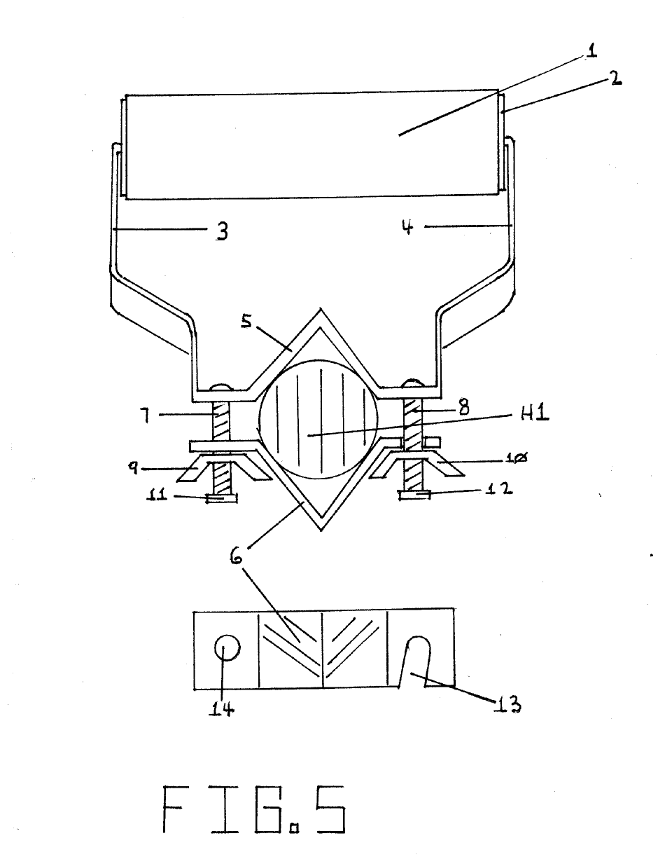

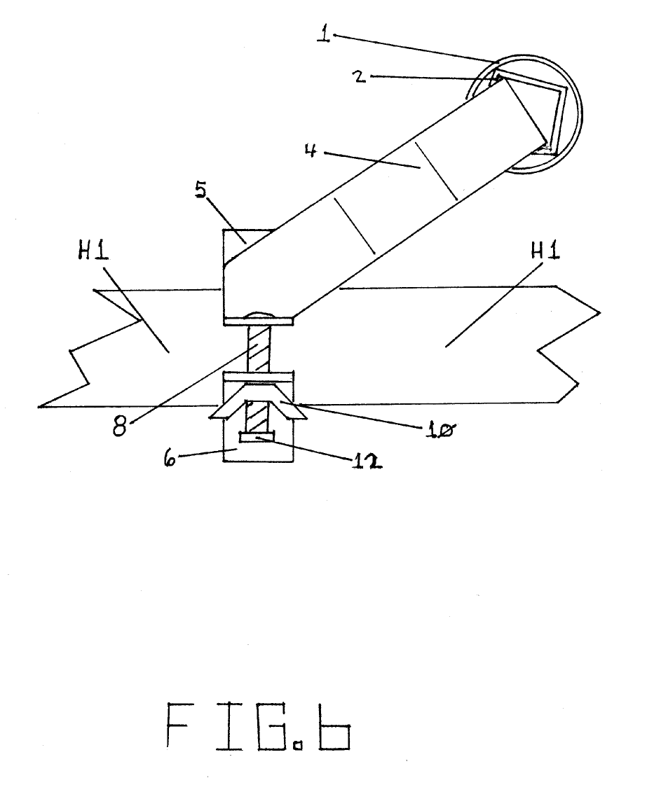

To create a Readygrip (FIG. 5) (FIG. 6) Rotate the upper one-half of the clamp 5 until the bottom is open and the treaded rods 7 and 8 extend downward. Position the upper end where the side rails 3 and 4 extend downward and attach the left side rail 3 to the left side of the top one-half of the clamp 5 and attach the right side rail 4 to the right side of the top one-half of the clamp 5. At the point in time that both left and right side rails have been attached to their respective sides of the upper one-half of the clamp 5, a Readygrip is complete.

A Readygrip (FIG. 5) (FIG. 6) may be attached to a tool handle H1 at any point selected along the length of the tool handle.

To attach a Readygrip (FIG. 5) (FIG. 6) to a tool handle H1, place the one-half of the clamp 5 that incorporates the threaded rods 7 and 8 on the tool handle H1 with the threaded rods 7 and 8 extending downward. Rotate the bottom one-half of the clamp 6 on the threaded rod 7 until the slotted portion 13 of the lower one-half of the clamp 6 is received by the remaining threaded rod 8 that extends down from the upper one-half of the clamp 5. Adjust the Readygrip (FIG. 5) (FIG. 6) on the tool handle H1 and tighten both wing nuts 9 and 10 equally. At the point in time that both wing nuts 9 and 10 have been tightened, the attachment of the Readygrip is complete.

Improvements made to that certain U.S. Pat. No. 5,499,852 known as “Second Handle Attachment for a Tool”:

1. The necessity to add sleeves or shims to accommodate for varying tool handle diameters has been negated.

2. The necessity to add sleeves or shims to accommodate for tool handles that have surfaces that are more or less than parallel to there axis has been negated.

3. The necessity for additional tool(s) to attach or adjust has been negated.

4. The necessity to disassemble the attachment to place the attachment on the tool handle has been negated.

5. The source of energy that causes tool handle rotation has been greatly reduced.

6. The possibility of the user slipping off of the handgrip has been greatly reduced.

7. The abrasive contacts between the user the tool and the attachment has been eliminated.

### DOCUMENT SEARCH

Patent Search by: Joel P. Steelman (inventor)

Current U.S. Class: 294/58; 16/426; 294/57

Intern'l Class: A01B 001/22

Field of Search: 294/57,58,545 16/426,427,429,438 37/265,285

### REFERENCES CITED (Referenced By)

U.S. Patent Documents

725905 Apr., 1903 Williams

930660 Aug., 1909 Gifford

933647 Sep., 1909 Hunt

3082554 Mar., 1963 Steeb

4050728 Sep., 1977 Davidson

4103954 Aug., 1978 Vaslas

4200324 Apr., 1980 Helton

4264096 Apr., 1981 Barnett

4615553 Oct., 1986 Hultine

4787661 Nov., 1988 Rutledge

4944541 Jul., 1990 Waldschmidt

5054830 Oct., 1991 Nisenbaum

5133582 Jul., 1992 Rocha

5472252 Dec., 1995 Barone

5499852 Mar., 1996 Seigendall

5871246 Feb., 1999 Simdom

6883845B2 Apr., 2005 Douziech

What is claimed is:

1. Readily attaches to, and is readily adjustable at any selected point along the length of tool handles that varies in diameter, without requiring additional sleeves or shims.

2. Readily attaches to and is readily adjustable on tool handles that have surfaces that are more or less than parallel to their axis without requiring additional sleeves or shims.

3. The use of any mechanical tool(s) to attach or adjust is negated.

4. The area of contact surface between the inner wall of the sleeve and the outside corner points of the square axle is considerably less than the surface contact area of a typical handgrip that rotates on an axle.

5. That portion gripped by the hand rotates on an axle preventing any abrasive contact between the user and the attachment or the tool.

6. Is readily adjustable per individual task on the same tool.

7. Is readily adjustable for multiple users on the same tool.

8. Is readily transferable from tool handle to tool handle.
